(19) United States
(12) Patent Application Publication
(10) Pub. No.: US 2021/0260991 A1
(43) Pub. Date: Aug. 26, 2021

(54) REFUELING PORT

(71) Applicant: Sumitomo Riko Company Limited, Aichi (JP)

(72) Inventors: Makoto Shimojo, Aichi (JP); Atsuo Miyajima, Aichi (JP); Eunjin Park, Aichi (JP); Takayuki Kobayashi, Aichi (JP)

(73) Assignee: Sumitomo Riko Company Limited, Aichi (JP)

(21) Appl. No.: 17/165,896

(22) Filed: Feb. 2, 2021

(30) Foreign Application Priority Data
Feb. 26, 2020 (JP) 2020-030141

(51) Int. Cl. B60K 15/04; B60K 15/05

(52) U.S. Cl. CPC B60K 15/04; B60K 2015/0438; B60K 15/05; B60K 15/0406

(57) ABSTRACT

Provided is a refueling port which can be manufactured at low cost. A refueling port includes: a refueling port main body made of resin; an inlet fitting formed in a tubular shape, arranged at an inlet opening of the refueling port main body, and having a groove on the outer peripheral surface; and a resin cover formed in a tubular shape, arranged on the outer peripheral side of the inlet fitting, having internal protrusions that engage with the groove of the inlet fitting in a tubular axial direction of the inlet fitting, and fitted to the inner peripheral surface of the inlet opening of the refueling port main body.

### CROSS REFERENCE TO RELATED APPLICATIONS

This application claims the priority benefit of Japanese Patent Application No. 2020-030141, filed on Feb. 26, 2020. The entirety of the above-mentioned patent application is hereby incorporated by reference herein and made a part of this specification.

### BACKGROUND

### Technical Field

The disclosure relates to a refueling port.

### Related Art

A refueling port described in patent literature 1 (Japanese Utility Model Application Laid-Open No. 4-113221) includes: a refueling port main body (inlet pipe) made of resin; an O-ring fitted onto the inner peripheral side of the refueling port main body; an inlet fitting (inlet retainer) fitted into an inlet opening of the refueling port main body; and a resin ring divided into two and welded to an axial end surface of the refueling port main body. The O-ring is sandwiched and pressurized between the resin ring and the refueling port main body.

A refueling port described in patent literature 2 (Japanese Utility Model Application Laid-Open No. 3-017398) includes: a refueling port main body (inlet pipe body) formed in a tubular shape and made of resin; an O-ring fitted onto the inner peripheral side of the refueling port main body; an inlet fitting (metal retainer) fitted into an inlet opening of the refueling port main body; and a resin ring integrally molded on the outer peripheral surface of the inlet fitting by injection molding. Besides, while the refueling port main body is inserted between the inner peripheral surface of the resin ring and the outer peripheral surface of the inlet fitting, internal protrusions of the resin ring are engaged with the outer peripheral surface of the refueling port main body. In addition, refueling ports described in patent literatures 3 to 5 (Japanese Utility Model Application Laid-Open No. 1-174222, Japanese Patent Application Laid-Open No. 2015-22624 and Japanese Patent No. 6510839) are known.

Here, because the inlet fitting is formed in a tubular shape and does not have a folded portion in the axial direction, the manufacturing cost can be reduced (see FIG. 3 of patent literature 2 for comparison). In addition, because the refueling port main body is required to have high performance in terms of rigidity and hardness, the refueling port main body is molded of a material having sufficient hardness. On the other hand, the required performance of the resin ring is not high compared with the refueling port main body. For example, the resin ring in patent literature 1 only needs to be capable of pressurizing the O-ring, and thus the required performance for rigidity and hardness is not high. However, in patent literature 1, the manufacturing cost of the resin ring is high in terms of being welded to the refueling port main body.

In patent literature 2, the refueling port main body (inlet pipe main body) is inserted between the injection-molded resin ring and the inlet fitting in the radial direction. Therefore, it is necessary for the resin ring to allow deformation when the refueling port main body is inserted and to exert a locking force with the refueling port main body after the refueling port main body is inserted. Therefore, the resin ring in patent literature 2 is required to have high performance in terms of rigidity and hardness. As a result, the resin ring may be expensive.

### SUMMARY

The disclosure provides a refueling port that can be manufactured at low cost.

A refueling port includes: a refueling port main body made of resin; an inlet fitting formed in a tubular shape, arranged at an inlet opening of the refueling port main body, and having a groove on an outer peripheral surface of the inlet fitting; and a cover made of resin and formed in a tubular shape, arranged on an outer peripheral side of the inlet fitting, having internal protrusions that engage with the groove of the inlet fitting in a tubular axial direction of the inlet fitting, and fitted to an inner peripheral surface of the inlet opening of the refueling port main body.

According to the refueling port, the inlet fitting can be formed in a tubular shape having no folded portion. Thus, the inlet fitting can be manufactured at low cost. In addition, the resin cover is fitted to the inner peripheral surface of the refueling port main body. In other words, the resin cover is sandwiched between the refueling port main body and the inlet fitting in the radial direction. When the cover is fitted to the refueling port main body, deformation of the cover is not allowed, and deformation of the refueling port main body is allowed. Thus, the refueling port main body is required to have high performance in terms of rigidity and hardness. However, because the refueling port main body is originally required to have high performance in terms of rigidity and hardness, it is not a factor that particularly increases the manufacturing cost. Then, different from the refueling port main body, the cover does not require high performance in terms of rigidity and hardness. Thus, the degree of freedom in designing the cover is increased.

### BRIEF DESCRIPTION OF THE DRAWINGS

FIG. 1 is a diagram of a fuel line.

FIG. 2 is a side view of a refueling port.

FIG. 3 is a top view of the refueling port and is a diagram when viewed from a III direction of FIG. 2.

FIG. 4 is an axial cross-sectional view of the refueling port and is a IV-IV cross-sectional view of FIG. 3.

FIG. 5 is an exploded perspective view of the refueling port.

FIG. 6 is an enlarged cross-sectional view of the refueling port on an inlet opening side in FIG. 4.

FIG. 7 is an axial cross-sectional view of a portion of a first cover element passing through an external protrusion on the inlet opening side of the refueling port.

FIG. 8A is a top view of the first cover element.

FIG. 8B is a front view of the first cover element (a diagram when viewed from a tubular axial direction of the refueling port).

FIG. 8C is a bottom view of the first cover element.

FIG. 9 is a front view of a second cover element.

FIG. 10 is a front view of the cover elements in a state that the first cover element and the second cover element are connected.

FIG. 11 is a side view of a ground fitting.

### DESCRIPTION OF THE EMBODIMENTS

(1. Configuration of Fuel Line 1)

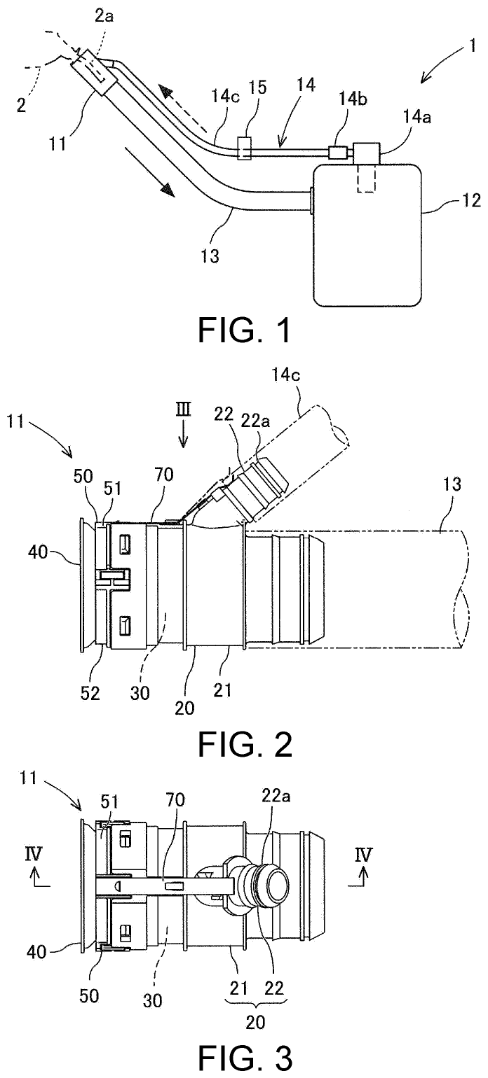

The configuration of a fuel line 1 is described with reference to FIG. 1. The fuel line 1 is a line from a refueling port 11 to an internal combustion engine (not shown) in an automobile. However, in this example, the portion from the refueling port 11 to a fuel tank 12, which is a part of the fuel line 1, is described.

The fuel line 1 includes the refueling port 11, the fuel tank 12, a filler pipe 13, and a breather line 14. The refueling port 11 is arranged near the outer surface of the automobile into which a nozzle 2a of a refueling gun 2 can be inserted. The refueling port 11 includes a type of refueling port on which a refueling cap not shown is mounted and a capless-type of refueling port on which the refueling cap is not mounted. The fuel tank 12 stores liquid fuel such as gasoline. The liquid fuel stored in the fuel tank 12 is supplied to the internal combustion engine (not shown) and used to drive the internal combustion engine.

The filler pipe 13 is formed of long resin hoses (also referred to as resin tubes). However, if necessary, the filler pipe 13 may also include joints for connecting the hoses. The filler pipe 13 connects the refueling port 11 and the fuel tank 12 and allows the supplied liquid fuel to flow in a forward direction. The nozzle 2a of the refueling gun 2 is inserted into the refueling port 11, and the liquid fuel is supplied from the nozzle 2a, and thereby the liquid fuel passes through the filler pipe 13 and is stored in the fuel tank 12. Here, when the fuel tank 12 is filled with the liquid fuel, the liquid fuel is stored in the filler pipe 13, and the liquid fuel comes into contact with the front end of the nozzle 2a of the refueling gun 2, and thereby the supply of the liquid fuel from the nozzle 2a is automatically stopped (auto stop function).

The breather line 14 connects the fuel tank 12 and the refueling port 11. The breather line 14 is a line for discharging fuel vapor in the fuel tank 12 to the outside of the fuel tank 12 when the liquid fuel is supplied to the fuel tank 12 via the filler pipe 13.

The breather line 14 includes a cut valve device 14a, a connector 14b, and a breather pipe 14c. The cut valve device 14a is arranged above the fuel tank 12, and when the cut valve device 14a is in the open state, the fuel vapor in the fuel tank 12 is discharged to the refueling port 11 side. The cut valve device 14a includes a connection pipe made of metal. The connector 14b is detachably connected to the connection pipe of the cut valve device 14a. The breather pipe 14c (also referred to as a breather tube or a breather hose) is formed of long resin hoses (also referred to as resin tubes). However, if necessary, the breather pipe 14c may also include joints for connecting the hoses. The breather pipe 14c connects the connector 14b and the refueling port 11.

In addition, during refueling, when the fuel tank 12 is full and the auto stop function is activated, the liquid fuel reflows from the fuel tank 12 to the refueling port 11 via the breather pipe 14c. In this way, the breather pipe 14c circulates the fuel vapor during refueling and the liquid reflow fuel during auto stop.

Furthermore, the breather pipe 14c is fixed to the automobile body by a metal bracket 15. Here, the inlet of the refueling port 11 is equipped with a metal inlet fitting (described later) in order to come into contact with the refueling gun 2. A ground path is secured at the inlet fitting. For example, the ground path is connected from the inlet fitting to the automobile body via the outer peripheral surface of the breather pipe 14c and the metal bracket 15. However, the ground path may be connected via the filler pipe 13 instead of the breather pipe 14c.

(2. Configuration of Refueling Port 11)

The configuration of the refueling port 11 shown in FIG. 1 is described with reference to FIGS. 2 to 11. The refueling port 11 includes a refueling port main body 20 made of resin, a nozzle guide 30 made of resin, an inlet fitting 40, a cover 50 made of resin, a seal unit 60, and a ground fitting 70.

The refueling port main body 20 is connected to the filler pipe 13 and the breather pipe 14c while the nozzle 2a (shown in FIG. 1) of the refueling gun 2 is inserted into the refueling port main body 20. As shown in FIGS. 2 to 5, the refueling port main body 20 includes a main tube portion 21 and a sub-tube portion 22 connected to the main tube portion 21. The refueling port main body 20 constitutes one member in which the main tube portion 21 and the sub-tube portion 22 are integrally molded by, for example, injection molding of resin. In particular, in this example, the refueling port main body 20 is molded of a non-conductive resin.

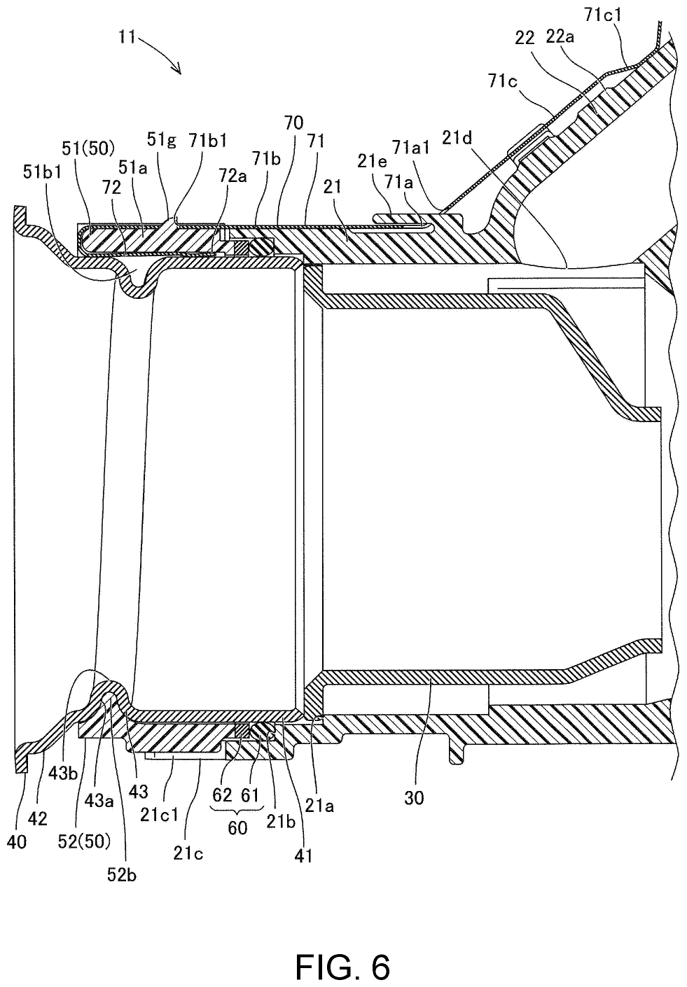

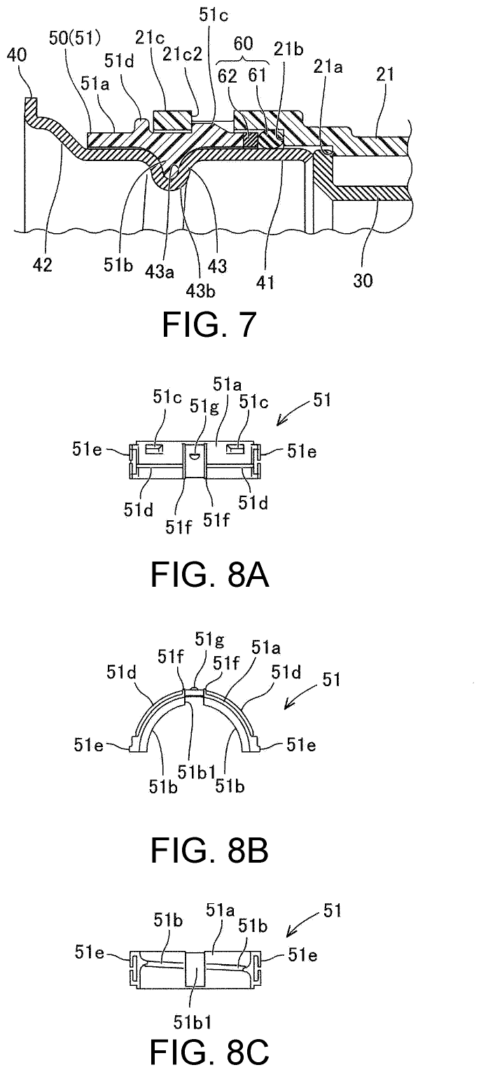

The main tube portion 21 is formed in a tubular shape having a linear central axis. The nozzle 2a is inserted into the main tube portion 21 on an inlet opening side, and the main tube portion 21 is connected to the filler pipe 13 on an outlet opening side. As shown in FIGS. 6 and 7, the main tube portion 21 has a nozzle guide support surface 21a on the inner peripheral surface. The nozzle guide support surface 21a has a stepped surface or a tapered surface so that the inlet opening side of the main tube portion 21 has a large diameter and the outlet opening side of the main tube portion 21 has a small diameter. In other words, the normal of the stepped surface or the tapered surface has a component of the main tube portion 21 on the inlet opening side.

As shown in FIGS. 6 and 7, the main tube portion 21 has a seal support surface 21b closer to the inlet opening side than the nozzle guide support surface 21a on the inner peripheral surface. The seal support surface 21b has a stepped surface so that the inlet opening side of the main tube portion 21 has a large diameter and the nozzle guide support surface 21a side has a small diameter. In other words, the normal of the stepped surface has a component of the main tube portion 21 on the inlet opening side.

As shown in FIGS. 6 and 7, the main tube portion 21 has a locking portion 21c closest to the inlet opening side. In other words, the locking portion 21c is located closer to the inlet opening side than the seal support surface 21b. The locking portion 21c has a slit 21c1 at the end on the inlet opening side. In the example, the locking portion 21c has a plurality of slits 21c1 in the circumferential direction. For example, the locking portion 21c has four slits 21c1 at intervals of about 90°. The slit 21c1 is formed from the end of the inlet opening of the main tube portion 21 toward the outlet opening side. In other words, the locking portion 21c has a plurality of (for example, four) arcuate peripheral walls that are independent in the circumferential direction.

Thus, the slit 21c1 has a function of making the locking portion 21c deformed more easily than a cylindrical shape.

Furthermore, as shown in FIGS. 6 and 7, each of the arcuate peripheral walls constituting the locking portion 21c has a recess 21c2 formed on the inner peripheral surface (the inner peripheral surface of the inlet opening of the main tube portion 21). In the example, the locking portion 21c has four recesses 21c2. The recess 21c2 may be a hole that penetrates in the radial direction or a non-penetrating recess that has a bottom surface on the outer side in the radial direction. Moreover, in the example, the recess 21c2 is exemplified as a penetrating hole.

As shown in FIG. 2, the filler pipe 13 is exteriorized on the outer peripheral surface of the main tube portion 21 on the outlet opening side. In particular, on the outer peripheral surface of the main tube portion 21 on the outlet opening side, the end of the filler pipe 13 is exteriorized in a state of being enlarged in diameter. A plurality of annular protrusions is formed at different positions in the axial direction on the outer peripheral surface of the main tube portion 21 on the outlet opening side in order to increase a coupling force with the filler pipe 13.

As shown in FIG. 6, the main tubular portion 21 has a reflow port 21d penetrating in the radial direction in an intermediate portion in the tubular axial direction. The reflow port 21d is located closer to the outlet opening side than the nozzle guide support surface 21a, and is located closer to the inlet opening side than the portion exteriorized to the filler pipe 13. In the circumferential direction, the reflow port 21d is located above the center in the vertical direction. For example, the reflow port 21d is located at the upper end in the circumferential direction.

As shown in FIG. 6, the main tube portion 21 further has a fitting support protrusion 21e protruding outward from the outer peripheral surface. The fitting support protrusion 21e is formed in the vicinity of the reflow port 21d and closer to the inlet opening than the reflow port 21d. The fitting support protrusion 21e is formed in, for example, an L shape having a front end on the inlet opening side.

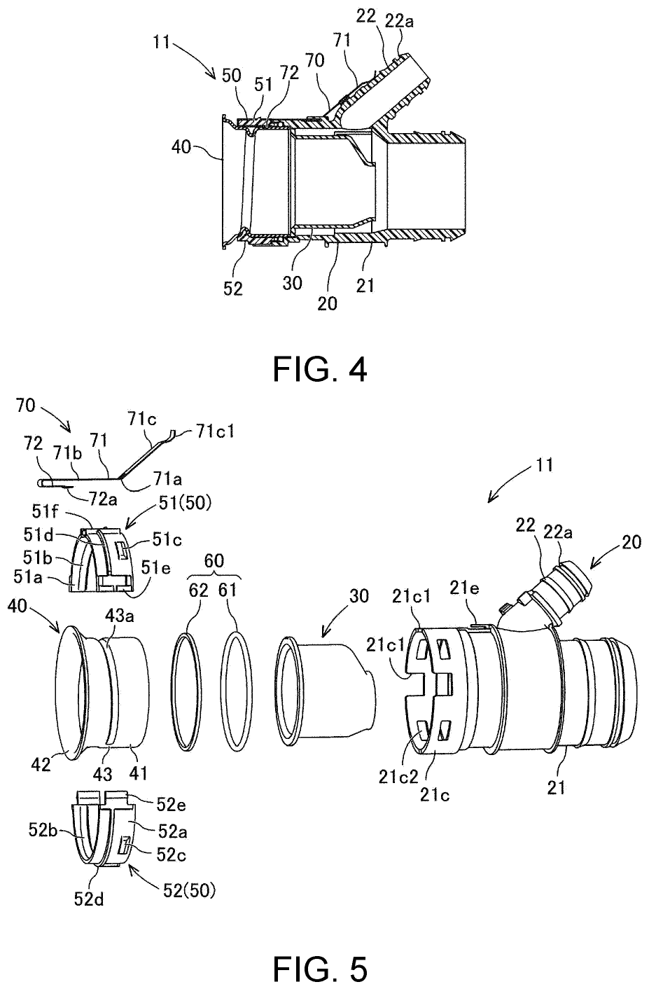

As shown in FIGS. 4 and 6, the sub-tube portion 22 is formed in a tubular shape, and one end thereof is connected to the reflow port 21d of the main tube portion 21. In the example, the sub-tube portion 22 is formed in a tubular shape having a linear central axis. However, the sub-tube portion 22 may be formed in an L-shaped tube for example. In addition, in the example, the tubular axial direction of the sub-tube portion 22 is connected to the main tube portion 21 in the manner of being inclined to the tubular axial direction of the main tube portion 21. In other words, the angle which is formed by the outer peripheral surface of the main tube portion 21 and a surface of the sub-tube portion 22 on the inlet opening side of the refueling port main body 20 is an obtuse angle.

In addition, as shown in FIG. 2, the sub-tube portion 22 is connected to the breather pipe 14c. Specifically, the sub-tube portion 22 includes, on the outer peripheral surface on the other end side, an exterior portion 22a to which the breather pipe 14c is exteriorized. In particular, on the outer peripheral surface of the exterior portion 22a of the sub-tube portion 22, the end of the breather pipe 14c is exteriorized in a state of being enlarged in diameter. On the outer peripheral surface of the exterior portion 22a of the sub-tube portion 22, a plurality of annular protrusions is formed at different positions in the axial direction in order to increase a coupling force with the breather pipe 14c. Here, in a state that the refueling port 11 is mounted on the automobile, the sub-tube portion 22 is arranged above the main tube portion 21. However, in the mounted state, the sub-tube portion 22 may be arranged on the side of the main tube portion 21.

As shown in FIGS. 4 to 6, the nozzle guide 30 is formed of resin in a tubular shape. The nozzle guide 30 guides the nozzle 2a of the refueling gun 2 inserted into the refueling port main body 20. The nozzle guide 30 is inserted into the main tube portion 21 of the refueling port main body 20. The nozzle guide 30 is formed so as to have a large diameter on one end side. The nozzle guide 30 is inserted into the inlet opening of the main tube portion 21 from the other end of the nozzle guide 30 on the small diameter side. Then, one end of the nozzle guide 30 on the large diameter side comes into contact with the nozzle guide support surface 21a, and thereby the nozzle guide 30 is located with respect to the main tube portion 21.

The nozzle guide 30 located in the main tube portion 21 faces the reflow port 21d in the radial direction. In other words, the outer peripheral surface of the nozzle guide 30 functions as a surface for receiving the fuel vapor and the reflow fuel that are reflowed from the reflow port 21d via the breather pipe 14c and the sub-tube portion 22. Then, the fuel vapor and the reflow fuel received by the outer peripheral surface of the nozzle guide 30 flow toward the outlet opening of the main tube portion 21.

As shown in FIGS. 4 to 7, the inlet fitting 40 is formed in a tubular shape and is arranged at the inlet opening of the main tube portion 21. The inlet fitting 40 is formed in a tubular shape having no folding back in the tubular axial direction. In addition, the inlet fitting 40 is formed by press-molding a cylindrical or flat plate-shaped material. The inlet fitting 40 includes a cylindrical portion 41 located on the outlet opening side, a tapered portion 42 located on the inlet opening side, and a groove forming portion 43 located between the cylindrical portion 41 and the tapered portion 42.

The cylindrical portion 41 is located at a position in the tubular axial direction where the seal support surface 21b in the main tubular portion 21 is located. The end of the cylindrical portion 41 in the tubular axial direction comes into contact with the end surface of the nozzle guide 30 in the tubular axial direction, and thereby the cylindrical portion 41 is located with the nozzle guide 30 sandwiched between the cylindrical portion 41 and the nozzle guide support surface 21a.

The tapered portion 42 is formed so as to have a large diameter on the inlet opening side. The tapered portion 42 is located closest to the inlet opening in the refueling port main body 20.

In other words, the tapered portion 42 is a member with which the refueling gun 2 can come into contact.

The groove forming portion 43 is a portion located between the cylindrical portion 41 and the tapered portion 42, and is located at a position in the tubular axial direction where the locking portion 21c of the main tube portion 21 is located. The groove forming portion 43 has a groove 43a on the outer peripheral surface. The groove 43a may be an annular outer peripheral groove or a spiral outer peripheral groove. In particular, the refueling port 11 in the example is exemplified as a refueling port having a cap. Therefore, the groove forming portion 43 has, on the inner peripheral surface, a female screw-shaped internal protrusion 43b for screwing a refueling cap not shown. Because the inlet fitting 40 is press-molded, a spiral outer peripheral groove 43a is formed in the groove forming portion 43 in an inverted shape on the outer peripheral side of the female screw-shaped internal protrusion 43b. Here, in general, the position of the female screw-shaped internal protrusion 43b in the circumferential direction is specified. For example, the end of the female screw-shaped internal protrusion 43b on the inlet opening side is specified to be located downward, and a pitch is also specified.

The cover 50 is molded of a non-conductive resin. As shown in FIGS. 4 to 7, the cover 50 is formed in a tubular shape as a whole. In the example, the cover 50 is formed separately from the inlet fitting 40. The cover 50 is mounted on the outer peripheral side of the inlet fitting 40. Moreover, the cover 50 may be formed by injection molding using the inlet fitting 40 as an insert. The cover 50 is fitted to the inner peripheral surface of the inlet opening of the main tube portion 21 of the refueling port main body 20. Specifically, a part of the cover 50 in the axial direction is fitted to the inner peripheral surface of each arcuate peripheral wall constituting the locking portion 21c of the main tube portion 21. In other words, a part of the cover 50 in the axial direction is an intervening member sandwiched between the locking portion 21c of the main tube portion 21 and the inlet fitting 40 in the radial direction.

Besides, the cover 50 is locked to the locking portion 21c of the main tube portion 21 in the tubular axial direction. Furthermore, the cover 50 is also locked to the inlet fitting 40 in the tubular axial direction by engaging with the groove 43a of the inlet fitting 40. In other words, the cover 50 is an intervening member for locating the inlet fitting 40 with respect to the main tube portion 21.

Specifically, the cover 50 includes a plurality of cover elements 51 and 52 formed in a shape in which the tubular shape is divided in the circumferential direction. In the example, the cover 50 includes two cover elements 51 and 52 obtained by dividing the cylinder in half. However, the cover 50 may include cover elements obtained by dividing the cylinder into three or more pieces. In addition, the cover elements 51 and 52 may have independent shapes, or may be connected by a connection tool (not shown) such as a hinge member in the manner that relative postures can be changed. The details of the two cover elements 51 and 52 are described below.

The first cover element 51 is arranged so as to face the range of the upper half of the inlet fitting 40. As shown in FIGS. 8A, 8B and 8C, the first cover element 51 includes a semi-cylindrical main body 51a, an internal protrusion 51b, an external protrusion 51c, a flange 51d, a pair of first locking portions 51e, a pair of guide protrusions 51f, and a ground fitting protrusion 51g.

The semi-cylindrical main body 51a is arranged in a range corresponding to a half circumference in the circumferential direction of the outer peripheral surface of the inlet fitting 40 and in a range corresponding to an intermediate portion of the inlet fitting 40 in the tubular axial direction. In particular, the semi-cylindrical main body 51a is located at a position radially facing the groove 43a of the inlet fitting 40. In addition, the end surface of the semi-cylindrical main body 51a in the tubular axial direction is arranged on the inlet opening side in the tubular axial direction at a distance from the stepped surface of the seal support surface 21b of the main tubular portion 21 of the refueling port main body 20. Besides, a part of the semi-cylindrical main body 51a is fitted closer to the inlet opening side than the stepped surface of the seal support surface 21b of the main tube portion 21, that is, fitted to the inner peripheral surface of the locking portion 21c.

The internal protrusion 51b protrudes radially inward from the inner peripheral surface of the main body 51a. The internal protrusion 51b extends in the circumferential direction. However, the internal protrusions 51b may be formed so as to be scattered instead of having a length. The internal protrusion 51b is arranged in a state of entering the groove 43a of the inlet fitting 40. Thus, the internal protrusion 51b engages with the groove 43a of the inlet fitting 40 in the tubular axial direction of the inlet fitting 40.

In the example, because the groove 43a of the inlet fitting 40 is a spiral outer peripheral groove, the internal protrusion 51b is a spiral protrusion corresponding to the spiral outer peripheral groove. In other words, the internal protrusion 51b engages with the portion formed in the upper half of the groove 43a of the inlet fitting 40. Because the groove 43a is spiral and the internal protrusion 51b is spiral, the first cover element 51 is located in the circumferential direction and the tubular axial direction with respect to the inlet fitting 40.

The internal protrusion 51b has a notch 51b1 at an intermediate position in the circumferential direction. In the example, the notch 51b1 is formed in a central portion of the main body 51a in the circumferential direction. In other words, the internal protrusion 51b has two protrusions separated at the center. Here, the central portion of the main body 51a in the circumferential direction matches, in the circumferential direction of the refueling port 11, the position at which the sub-tube portion 22 is arranged with respect to the main tube portion 21. Furthermore, the notch 51b1 of the internal protrusion 51b matches, in the circumferential direction, one of the slits 21c1 (upper slit) of the locking portion 21c of the main tube portion 21.

The external protrusion 51c protrudes radially outward from the outer peripheral surface of the main body 51a. The external protrusion 51c is formed closer to the outlet opening (the outlet opening of the refueling port 11) side than the internal protrusion 51b in the main body 51a. The external protrusion 51c is formed at a position corresponding to the recess 21c2 of the locking portion 21c of the main tube portion 21 in the circumferential direction. Because the first cover element 51 corresponds to 180° in the circumferential direction, the first cover element 51 has two external protrusions 51c at positions separated by about 90°. Besides, the external protrusion 51c is formed at a position different from the position of the notch 51b1 of the internal protrusion 51b in the circumferential direction. The external protrusion 51c engages with the recess 21c2 of the locking portion 21c of the main tube portion 21 in the tubular axial direction of the main tube portion 21.

The flange 51d protrudes radially outward from the outer peripheral surface of the main body 51a. In particular, the flange 51d is formed so as to extend in the circumferential direction on the outer peripheral surface of the main body 51a. The flange 51d is formed closer to the inlet opening (the inlet opening of the refueling port 11) side than the external protrusion 51c. The flange 51d is used as a jig support surface when the cover 50 is fitted to the refueling port main body 20. Specifically, the surface of the flange 51d on the inlet opening side is the jig support surface.

The pair of first locking portions 51e is formed at both ends of the main body 51a in the circumferential direction and used for locking with a second locking portion 52e (described later) of the second cover element 52. The first locking portion 51e has a through hole, and a slit is formed in the first locking portion 51e so as to allow passage of the second locking portion 52e of the second cover element 52. The first locking portion 51e protrudes radially outward with respect to the main body 51a.

The pair of guide protrusions 51f protrudes radially outward from the outer peripheral surface of the main body 51a. The pair of guide protrusions 51f extends in the tubular axial direction and is formed parallel to each other. The guide protrusion 51f matches the notch 51b1 of the internal protrusion 51b in the circumferential direction. In other words, the guide protrusion 51f is arranged in one of the slits 21c1 (upper slit) of the locking portion 21c of the main tube portion 21 in the circumferential direction. Thus, the guide protrusion 51f is arranged to be non-rotatable with respect to the locking portion 21c of the main tube portion 21.

The ground fitting protrusion 51g protrudes radially outward from the outer peripheral surface of the main body 51a between the pair of guide protrusions 51f. As shown in FIG. 6, the ground fitting protrusion 51g has an inclined surface on the inlet opening side (left side in FIG. 6) and has a plane orthogonal to the tubular axial direction on the outlet opening side (right side in FIG. 6).

The second cover element 52 is arranged so as to face the range of the lower half of the inlet fitting 40. The second cover element 52 includes a semi-cylindrical main body 52a, an internal protrusion 52b, an external protrusion 52c, a flange 52d, a pair of second locking portions 52e, and a guide protrusion 52f. Each of the semi-cylindrical main body 52a, the internal protrusion 52b, the external protrusion 52c, and the flange 52d has substantially the same configuration as each of the semi-cylindrical main body 51a, the internal protrusion 51b, the external protrusion 51c, and the flange 51d in the first cover element 51.

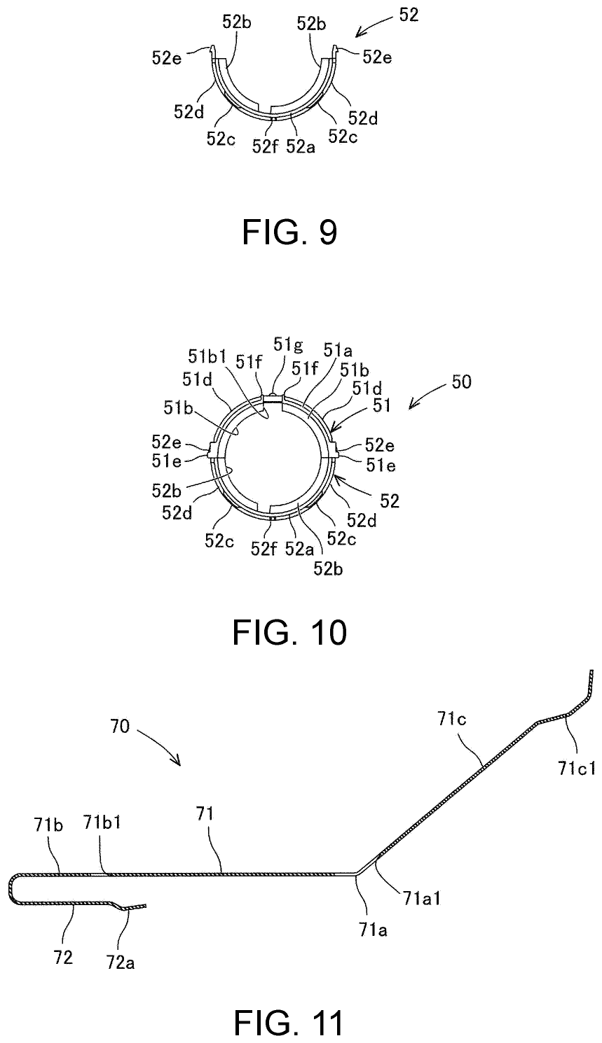

The pair of second locking portions 52e is formed at both ends of the main body 52a in the circumferential direction and used for locking with the first locking portion 51e of the first cover element 51. As shown in FIG. 9, the second locking portion 52e is a claw that passes through and locks with the first locking portion 51e of the first cover element 51. The second locking portion 52e protrudes radially outward with respect to the main body 52a.

The guide protrusion 52f protrudes radially outward from the outer peripheral surface of the main body 52a. The guide protrusion 52f extends in the tubular axial direction. The guide protrusion 52f is arranged in one of the slits 21c1 (lower slit) of the locking portion 21c of the main tube portion 21 in the circumferential direction. Thus, the guide protrusion 52f is arranged to be non-rotatable with respect to the locking portion 21c of the main tube portion 21.

Here, as shown in FIG. 10, in a state that the first locking portion 51e of the first cover element 51 and the second locking portion 52e of the second cover element 52 are locked with each other, the first locking portion 51e and the second locking portion 52e are arranged in two of the slits 21c1 (side slits) of the locking portion 21c of the main tube portion 21 in the circumferential direction. Thus, the first locking portion 51e and the second locking portion 52e are arranged to be non-rotatable with respect to the locking portion 21c of the main tube portion 21.

As shown in FIGS. 6 and 7, the seal unit 60 is sandwiched between the inner peripheral surface of the main tube portion 21 and the outer peripheral surface of the cylindrical portion 41 of the inlet fitting 40 in the radial direction. Furthermore, the seal unit 60 is sandwiched between the seal support surface 21b of the main tube portion 21 and the cover 50 in the tubular axial direction. The seal unit 60 includes a seal member 61 and a collar member 62. The seal member 61 is, for example, an O-ring, and the collar member 62 is, for example, an annular resin member.

As shown in FIG. 6, the ground fitting 70 is formed in a long shape and is electrically connected to the inlet fitting 40. The ground fitting 70 is, for example, a long leaf spring made of spring steel. As shown in FIGS. 6 and 11, the ground fitting 70 is formed in a long plate shape by bending. The ground fitting 70 includes an exposed portion 71 and an insertion portion 72.

The exposed portion 71 is arranged so as to face the outer peripheral surface of the refueling port main body 20 and to face the outer peripheral surface of the cover 50. The exposed portion 71 is formed from the outer peripheral surface of the main tube portion 21 of the refueling port main body 20 along the outer peripheral surface of the sub-tube portion 22. The first end of the exposed portion 71 is located on the inlet side of the cover 50, and the second end is located on the outlet side of the sub-tube portion 22.

The exposed portion 71 has an intermediate portion 71a formed by bending at a joint portion between the main tube portion 21 and the sub-tube portion 22. In other words, in the example, the intermediate portion 71a is formed by bending in the manner that the formed angle is an obtuse angle. Here, in the exposed portion 71, the portion closer to the inlet opening side of the main tube portion 21 than the intermediate portion 71a is set as a fixation portion 71b, and the portion closer to the outlet opening side of the sub-tube portion 22 than the intermediate portion 71a is set as a deformation portion 71c.

The intermediate portion 71a is a bending portion and has a through hole 71a1. The through hole 71a1 of the intermediate portion 71a engages with the fitting support protrusion 21e of the main tube portion 21. In this way, the intermediate portion 71a is supported in a state that the portion formed by bending is located on the outer peripheral surface of the main tube portion 21.

The fixation portion 71b is formed in a long flat plate shape, and is arranged to face the outer peripheral surface of the main tube portion 21 and the outer peripheral surface of the cover 50 so as to extend in the tubular axial direction of the main tube portion 21. One end of the fixation portion 71b (the first end of the exposed portion 71) is located at the inlet opening of the first cover element 51, and the other end of the fixation portion 71b is located at the joint portion between the main tube portion 21 and the sub-tube portion 22. The fixation portion 71b is located between the pair of guide protrusions 51f of the first cover element 51. The fixation portion 71b has a through hole 71b1. The through hole 71b1 of the fixation portion 71b engages with the ground fitting protrusion 51g of the first cover element 51.

The deformation portion 71c is formed in a long shape, and is arranged to face the outer peripheral surface of the sub-tube portion 22 so as to extend in the tubular axial direction of the sub-tube portion 22. One end of the deformation portion 71c is fixed to the main tube portion 21 at the intermediate portion 71a, while the other end of the deformation portion 71c is not fixed to the sub-tube portion 22. Thus, the deformation portion 71c is elastically deformable with the intermediate portion 71a as a fulcrum due to the elastic deformation of the leaf spring.

The other end of the deformation portion 71c (the second end of the exposed portion 71) has a front end curved portion 71c1 that is formed by bending. In the example, the front end curved portion 71c1 is formed in the manner of being curved and convex toward the sub-tube portion 22 side. The front end curved portion 71c1 faces the exterior portion 22a of the sub-tube portion 22. Here, the exposed portion 71 is a leaf spring. Thus, in an initial state that the breather pipe 14c is not exteriorized to the exterior portion 22a of the sub-tube portion 22, the front end curved portion 71c1 comes into contact with the outer peripheral surface of the sub-tube portion 22 in an urged state due to the elastic deformation of the leaf spring. Furthermore, when the breather pipe 14c is exteriorized to the exterior portion 22a of the sub-tube portion 22, the deformation portion 71c is elastically deformed with the intermediate portion 71a as a fulcrum, and the front end curved portion 71c1 comes into contact with the outer peripheral surface of the breather pipe 14c in an urged state.

The insertion portion 72 is formed by folding back from the inlet-side end of the fixation portion 71b of the exposed portion 71 (the first end of the exposed portion 71). The insertion portion 72 is sandwiched between the outer peripheral surface of the inlet fitting 40 and the inner peripheral surface of the first cover element 51. The insertion portion 72 is arranged in the notch 51b1 of the internal protrusion 51b of the first cover element 51. In other words, the insertion portion 72 extends closer to the outlet opening side of the main tube portion 21 than the internal protrusion 51b of the first cover element 51.

The insertion portion 72 has a front end curved portion 72a formed by bending at the front end thereof. In the example, the front end curved portion 72a is formed in the manner of being curved and convex toward the cylindrical portion 41 side of the inlet fitting 40. Here, the insertion portion 72 is a leaf spring. Thus, the front end curved portion 72a of the insertion portion 72 comes into contact with the outer peripheral surface of the cylindrical portion 41 of the inlet fitting 40 in an urged state due to the elastic deformation of the leaf spring.

(3. Manufacturing Method of Refueling Port 11)

A manufacturing method (assembly method) of the refueling port 11 is described with reference to FIG. 5. The nozzle guide 30 is inserted into the main tube portion 21 of the refueling port main body 20 from the inlet opening side of the main tube portion 21. The end of the nozzle guide 30 is located at a position in contact with the nozzle guide support surface 21a of the main tube portion 21.

Subsequently, the seal member 61 and the collar member 62 are inserted into the main tube portion 21 of the refueling port main body 20 from the inlet opening side of the main tube portion 21. The seal member 61 is located at a position in contact with the seal support surface 21b of the main tube portion 21. The seal member 61 is also in contact with the inner peripheral surface of the main tube portion 21. The collar member 62 is in contact with the seal member 61.

Different from the insertion of the nozzle guide 30, the seal member 61, and the collar member 62 into the main tube portion 21, the first cover element 51 and the second cover element 52 are mounted on the outer peripheral surface of the inlet fitting 40. At this time, the internal protrusion 51b of the first cover element 51 and the internal protrusion 52b of the second cover element 52 engage with the groove 43a on the outer peripheral surface of the inlet fitting 40.

Then, the first locking portion 51e of the first cover element 51 and the second locking portion 52e of the second cover element 52 are locked to each other. In this state, the inlet fitting 40, the first cover element 51, and the second cover element 52 are integrated.

Subsequently, the integrated inlet fitting 40, first cover element 51, and second cover element 52 are inserted into the main tube portion 21 from the inlet opening side of the main tube portion 21. At this time, it is necessary to support and press the refueling port main body 20 and the integrated member including the inlet fitting 40 by respective jigs (not shown). The refueling port main body 20 can support an arbitrary portion with a jig.

Here, the inlet fitting 40 requires high sealing performance due to mounting of a refueling cap. Besides, the inlet fitting 40 does not have high rigidity because the thickness is not sufficient.

Thus, the inlet fitting 40 should not be brought into contact with the jig. Therefore, in the integrated member including the inlet fitting 40, the flange 51d of the first cover element 51 and the flange 52d of the second cover element 52 are used as the portions supported by the jig. In this way, the cover elements 51 and 52 can be prevented from coming into contact with the jig by having the flanges 51d and 52d.

Then, a part of the inlet fitting 40, a part of the first cover element 51, and a part of the second cover element 52 are fitted to the inner peripheral surface of the locking portion 21c of the main tube portion 21. At the time of fitting, the guide protrusion 51f of the first cover element 51, the guide protrusion 52f of the second cover element 52, the first locking portion 51e of the first cover element 51, and the second locking portion 52e of the second cover element 52 are guided by the slit 21c1 of the locking portion 21c of the main tube portion 21. Besides, each guided portion exerts a rotation restriction function in the circumferential direction with respect to the slit 21c1 of the locking portion 21c of the main tube portion 21.

Furthermore, the external protrusion 51c of the first cover element 51 and the external protrusion 52c of the second cover element 52 engage with the recess 21c2 of the locking portion 21c of the main tube portion 21. By the engagement, the inlet fitting 40, the first cover element 51, and the second cover element 52 are located in the circumferential direction and the tubular axial direction with respect to the main tube portion 21.

In this state, the cylindrical portion 41 of the inlet fitting 40 is inserted to the position of the seal member 61. Thus, the seal member 61 is in contact with the outer peripheral surface of the cylindrical portion 41 of the inlet fitting 40 and the inner peripheral surface of the main tube portion 21 in an urged state.

Subsequently, the ground fitting 70 is attached. The insertion portion 72 of the ground fitting 70 is inserted from the inlet opening side of the first cover element 51 to the position of the notch 51b1 of the internal protrusion 51b of the first cover element 51. Then, the through hole 71b1 of the fixation portion 71b of the exposed portion 71 of the ground fitting 70 engages with the ground fitting protrusion 51g of the first cover element 51, and the through hole 71a1 of the intermediate portion 71a of the exposed portion 71 engages with the fitting support protrusion 21e of the main tube portion 21. In this state, the front end curved portion 72a of the insertion portion 72 of the ground fitting 70 comes into contact with the outer peripheral surface of the cylindrical portion 41 of the inlet fitting 40 in an urged state while being elastically deformed. Furthermore, the front end curved portion 71c1 of the deformation portion 71c of the exposed portion 71 of the ground fitting 70 comes into contact with the outer peripheral surface of the exterior portion 22a of the sub-tube portion 22 in an urged state. In addition, a refueling cap not shown is mounted. In this way, the refueling port 11 is completed.

Then, the filler pipe 13 is exteriorized to the outer peripheral surface of the main tube portion 21 on the outlet opening side. In addition, the breather pipe 14c is exteriorized to the exterior portion 22a of the sub-tube portion 22 on the outlet opening side. Here, in a state that the breather pipe 14c is exteriorized to the exterior portion 22a of the sub-tube portion 22, the deformation portion 71c of the exposed portion 71 of the ground fitting 70 is elastically deformed, and thereby the front end curved portion 71c1 of the deformation portion 71c comes into contact with the outer peripheral surface of the breather pipe 14c in an urged state.

(4. Ground Path)

A ground path from the inlet fitting 40 is connected to the automobile body via the inlet fitting 40, the insertion portion 72 of the ground fitting 70, the exposed portion 71 of the ground fitting 70, the outer peripheral surface of the breather pipe 14c, and the metal bracket 15.

The ground fitting 70 includes the exposed portion 71 and the insertion portion 72 formed by folding back from the exposed portion 71. Besides, the insertion portion 72 is inserted into the gap between the inlet fitting 40 and the cover 50. Thus, the inlet fitting 40 is formed in a tubular shape having no folded portion, and the ground path of the inlet fitting 40 can be secured by the ground fitting 70. In this way, the ground fitting 70 can be easily attached, and the inlet fitting 40 and the ground fitting 70 can be reliably connected. In addition, the insertion portion 72 of the ground fitting 70 is inserted into the notch 51b1 of the internal protrusion 51b of the first cover element 51. Thus, the insertion of the insertion portion 72 of the ground fitting 70 becomes very easy.

In addition, the front end curved portion 72a of the insertion portion 72 of the ground fitting 70 comes into contact with the outer peripheral surface of the inlet fitting 40 in an urged state. In particular, because the insertion portion 72 is formed by a leaf spring, the front end curved portion 72a of the insertion portion 72 comes into contact with the outer peripheral surface of the inlet fitting 40 in an urged state due to the elastic deformation of the leaf spring. Thus, the ground fitting 70 can be reliably brought into contact with the inlet fitting 40.

The front end curved portion 71c1 of the deformation portion 71c of the exposed portion 71 of the ground fitting 70 faces the exterior portion 22a of the sub-tube portion 22 and is in contact with the outer peripheral surface of the breather pipe 14c mounted on the exterior portion 22a. Thus, the ground path from the deformation portion 71c of the ground fitting 70 to the breather pipe 14c is reliably secured. In particular, because the exposed portion 71 is formed by a leaf spring, the front end curved portion 71c1 of the deformation portion 71c of the exposed portion 71 comes into contact with the outer peripheral surface of the breather pipe 14c in an urged state due to the elastic deformation of the leaf spring. Thus, the ground fitting 70 can be reliably brought into contact with the breather pipe 14c.

In addition, the intermediate portion 71a of the exposed portion 71 of the ground fitting 70 is supported by the fitting support protrusion 21e of the main tube portion 21. Thus, the deformation portion 71c is elastically deformed with the intermediate portion 71a as a fulcrum.

Therefore, the deformation portion 71c of the exposed portion 71 of the ground fitting 70 can come into contact with the breather pipe 14c in an urged state. In particular, the intermediate portion 71a is formed by bending in the manner that the formed angle is an obtuse angle. Therefore, the deformation portion 71c can reliably exert an urging force on the breather pipe 14c.

(5. Effect)

According to the refueling port 11, the inlet fitting 40 can be formed in a tubular shape having no folded portion. Thus, the inlet fitting 40 can be manufactured at low cost.

In addition, the resin cover 50 is fitted to the inner peripheral surface of the main tube portion 21 of the refueling port main body 20. In other words, the resin cover 50 is sandwiched between the main tube portion 21 and the inlet fitting 40 in the radial direction. When the cover 50 is fitted to the main tube portion 21, deformation of the cover 50 is not allowed, and deformation of the main tube portion 21 is allowed. Thus, the refueling port main body 20 is required to have high performance in terms of rigidity and hardness. However, because the refueling port main body 20 is originally required to have high performance in terms of rigidity and hardness, it is not a factor that particularly increases the manufacturing cost. Besides, different from the refueling port main body 20, the cover 50 does not require high performance in terms of rigidity and hardness. Thus, the degree of freedom in designing the cover 50 is increased.

In addition, by fitting the cover 50 to the inner peripheral surface of the main tube portion 21, the seal unit 60 can be sandwiched and arranged between the cover 50 and the seal support surface 21b of the main tube portion 21. In this case, the seal support surface 21b of the main tube portion 21 has a shape that can be seen from the inlet opening side of the main tube portion 21. In other words, the seal support surface 21b of the main tube portion 21 does not have an undercut shape when viewed from the inlet opening side of the main tube portion 21. Thus, the main tube portion 21 has a shape easy to manufacture and can be manufactured at low cost.

Furthermore, the locking portion 21c of the main tube portion 21 includes a penetrating recess 21c2 that engages with the external protrusions 51c and 52c of the cover elements 51 and 52. By using the recess 21c2 as a through hole, the main tube portion 21 does not have an undercut shape from this point as well.

The cover 50 is formed separately from the inlet fitting 40 and is mounted in a state of being engaged with the inlet fitting 40. In other words, the cover 50 is not injection-molded with the inlet fitting 40 as an insert. Thus, the cover 50 can be easily manufactured and the cost can be reduced. Although the cover 50 is separate from the inlet fitting 40, the internal protrusions 51b and 52b of the cover 50 engage with the groove 43a of the inlet fitting 40 and thereby the cover 50 and the inlet fitting 40 are relatively located. In particular, the groove 43a utilizes a spiral outer peripheral groove formed on the outer peripheral side of the female screw-shaped internal protrusion 43b for screwing a refueling cap (not shown). Thus, it is not necessary to form a dedicated groove for engaging with the internal protrusions 51b and 52b of the cover 50. Furthermore, because the groove 43a has a spiral shape, the cover 50 and the inlet fitting 40 can be relatively located in the circumferential direction and the tubular axial direction.

In addition, the cover 50 includes a plurality of cover elements 51 and 52, and the locking portions 51e and 52e for locking the cover elements 51 and 52 protrude radially outward. The locking portions 51e and 52e protruding radially outward are arranged in the slit 21c1 of the main tube portion 21, and thereby the cover 50 is arranged to be non-rotatable with respect to the main tube portion 21. In this way, the locking portions 51e and 52e can have not only a function of locking the cover elements 51 and 52 but also a function of positioning the main tube portion 21.

Here, the slit 21c1 of the locking portion 21c of the main tube portion 21 exerts a rotation restriction function obtained by arranging the locking portions 51e and 52e and the like.

Furthermore, the slit 21c1 functions to make the locking portion 21c more easily deformed than the cover 50 when the cover 50 is fitted to the locking portion 21c. In this way, the slit 21c1 exerts a plurality of functions.

It will be apparent to those skilled in the art that various modifications and variations can be made to the disclosed embodiments without departing from the scope or spirit of the disclosure.

In view of the foregoing, it is intended that the disclosure covers modifications and variations provided that they fall within the scope of the following claims and their equivalents.

File: What is claimed is:

1. A refueling port, comprising:
a refueling port main body made of resin;
an inlet fitting formed in a tubular shape, arranged at an inlet opening of the refueling port main body, and having a groove on an outer peripheral surface of the inlet fitting; and
a cover made of resin and formed in a tubular shape, arranged on an outer peripheral side of the inlet fitting, having internal protrusions that engage with the groove of the inlet fitting in a tubular axial direction of the inlet fitting, and fitted to an inner peripheral surface of the inlet opening of the refueling port main body.

2. The refueling port according to claim 1, wherein the cover is molded separately from the inlet fitting,
the cover comprises a plurality of intervening elements formed in a shape obtained by dividing a tubular shape in a circumferential direction of the cover,
each of the plurality of intervening elements comprises the internal protrusion that engages with the groove of the inlet fitting, and
the plurality of intervening elements is mounted on the outer peripheral side of the inlet fitting.

3. The refuelling port according to claim 2, wherein the inlet fitting has a female screw-shaped internal protrusion for screwing a refueling cap on the inner peripheral surface of inlet fitting, and has a spiral outer peripheral groove serving as the groove on an outer peripheral side of the female screw-shaped internal protrusion,
the internal protrusion in the plurality of intervening elements is a spiral protrusion corresponding to the spiral outer peripheral groove, and
the plurality of intervening elements engages the internal protrusion with the spiral outer peripheral groove in the tubular axial direction of the inlet fitting, and is located in the circumferential direction with respect to the inlet fitting.

4. The refueling port according to claim 2, further comprising a slit at an end of the refueling port main body on the inlet opening side, wherein
the plurality of intervening elements comprises a locking portion for locking the intervening elements with each other, and
the locking portion protrudes radially outward with respect to a main body of the plurality of intervening elements and is arranged in the slit of the refueling port main body, thereby being non-rotatably arranged with respect to the refueling port main body.

5. The refueling port according to claim 1, wherein the refueling port main body comprises recesses on the inner peripheral surface of the inlet opening, and
the cover comprises external protrusions that engage with the recesses on an outer peripheral surface in the tubular axial direction of the refueling port main body.

6. The refueling port according to claim 5, further comprising a slit that is deformed more easily than the cover at an end of the refueling port main body on the inlet opening side.

7. The refueling port according to claim 1, wherein the cover has a flange extending in the circumferential direction on an outer peripheral surface of the cover, and
the flange is a jig support surface in a state that the cover is fitted to the refueling port main body.

8. The refueling port according to claim 1, wherein the refueling port main body comprises a stepped surface having a large diameter on the inlet opening side on the inner peripheral surface of the refueling port main body,
the cover is arranged on the inlet opening side in the tubular axial direction at a distance from the stepped surface of the refueling port main body, and is fitted closer to the inner peripheral surface on the inlet opening side than the stepped surface in the refueling port main body, and
the refueling port further comprises
a seal member that is arranged between the cover and the stepped surface of the refueling port main body in the tubular axial direction, and is in contact with the inner peripheral surface of the refueling port main body on the inlet opening side and the outer peripheral surface of the inlet fitting.
